(19) United States
(12) Patent Application Publication
(10) Pub. No.: US 2005/0232117 A1
(43) Pub. Date: Oct. 20, 2005

(54) SYNTHETIC NUMERICAL APERTURE DEVICE AND METHOD

(75) Inventor: Robison J. Bryan, North Hills, CA (US)

Correspondence Address: DISCOVISION ASSOCIATES;INTELLECTUAL PROPERTY DEVELOPMENT, 2355 MAIN STREET, SUITE 200, IRVINE, CA, 92614, US

(73) Assignee: DISCOVISION ASSOCIATES, Irvine, CA (US)

(21) Appl. No.: 10/907,292

(22) Filed: Mar. 28, 2005

Related U.S. Application Data
(60) Provisional application No. 60/521,380, filed on Apr. 14, 2004.

(51) Int. Cl. G11B 7/00

(52) U.S. Cl. 369/112.01; 369/112.28

(57) ABSTRACT

The present invention is a numerical aperture device and method. According to an embodiment of the present invention, a beam from a light source is caused to contact a numerical aperture (NA) plate. The NA plate has a first and second surface. The first surface splits the beam into two twin rays and directs the twin beams into adjacent and oppositely oriented re-direction elements within the first surface of the NA plate. The two twin rays are directed in opposite directions from each other (and 90 degrees apart from each other) such that as they traverse a specific distance through an internal area of the NA plate before striking the second surface of the plate. As the twin beams leave the NA plate's second surface they converge together and meet at the location of the medium to produce a spot.

The present application claims priority to the provisional patent application entitled SYNTHETIC NUMERICAL APERTURE DEVICE AND METHOD, Ser. No. 60/521,380, filed on Apr. 14, 2004.

### BACKGROUND OF THE INVENTION

The minimum spot size for a coherent beam is limited by the numerical aperture (NA), which is a function of the converging angle for the marginally focused rays (rays on the outer edges). Current focus systems achieve a high converging angle for the marginally focused rays by placing the objective lens as close to the media as possible. Consequently, any system wherein the final focus is accomplished over a distance is problematic because the converging angle of the outer rays become too small and the spot on the medium becomes too large.

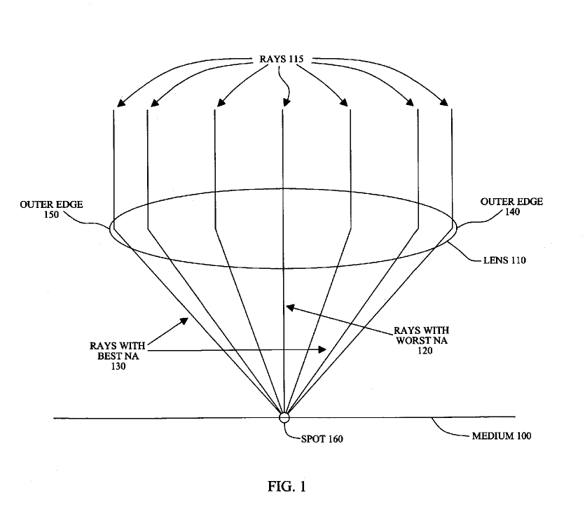

FIG. 1 is an example of a known focusing system. Objective lens 110 is placed as close as possible to medium 100. Rays 115 are passed from a light source, through objective lens 110 and produce spot 160 on medium 100. Rays with the best NA 130 pass through objective lens 110 relatively close to outer edges 140 and 150. Rays with the worst NA 120 pass near the center of lens 110. Thus, rays with the highest converging angle are most desirable and this angle is increased as lens 110 is moved closer to medium 100, and consequently the size of spot 160 is reduced.

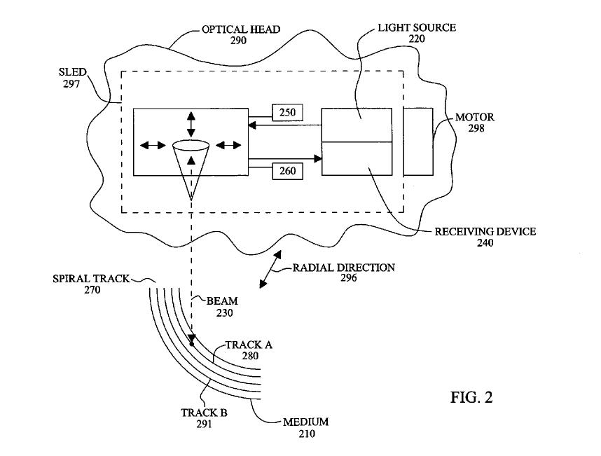

Current optical media players that include focus systems operate generally as shown in FIG. 2 in order to allow a user to listen to a song or watch a movie. The player holds an optical medium 210, such as a CD or DVD. The medium 210 is caused to spin, and a light source 220 directs an optical beam 230 to the medium 210. The beam 230 then reflects back to a receiving device 240, typically via a reflector (not shown), where a focusing function 250 and a tracking function 260 work in tandem to make beam 230 both the in the right shape and size, and in the right place. As time passes (through a combination of spinning the medium 210 and the tracking function 260), the beam 230 may be directed across the entire spiral track 270 so that the entire CD or DVD can be watched, recorded, and/or listened to. Similarly, the beam 230 can be moved between tracks, for instance track A 280 and track B 291, when the user jumps between scenes and/or songs.

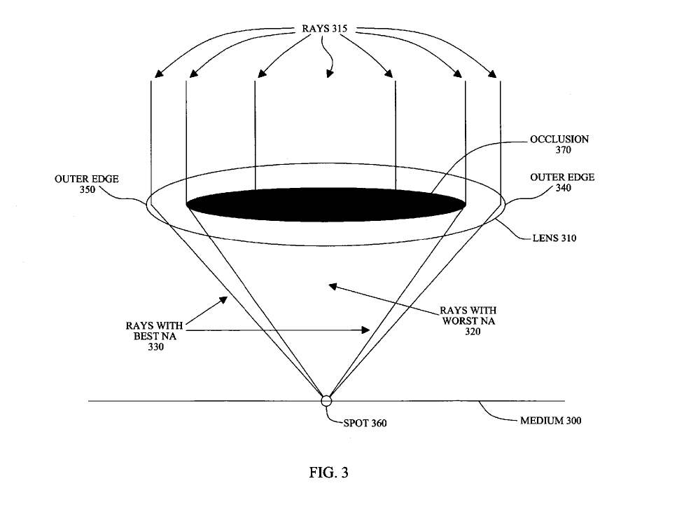

An analysis of the converging beam shows that the rays on each edge of the objective lens do not differ much in converging angle, but that there is an opposing wavefront established between the rays on one edge and the rays on the other edge. This is demonstrated by occluding (painting) the center of an existing objective lens and nonetheless establishing a small spot size. FIG. 3 shows an example of a center occluded optical lens and the converging behavior of the rays when the objective lens placed near the medium. Objective lens 310 is placed as close as possible to medium 300. Rays 315 are passed from a light source, through objective lens 310 and produce spot 360 on medium 300. Rays with the best NA 330 pass through objective lens 310 relatively close to outer edges 340 and 350. Rays with the worst NA 320 pass near the center of lens 310 and are obstructed by occlusion 370.

Thus, rays with the highest converging angle are most desirable and this angle is increased as lens 310 is moved closer to medium 300, and consequently the size of spot 360 is reduced. The high converging angle of rays 330 of FIG. 3 creates an opposing group of wavefronts near spot 360. The opposing group of wavefronts work in cooperation to make the spot 360 smaller and rounder in a more optimal way. In the example of FIG. 3 the rays with the best NA 330 are allowed to pass through lens 310, while rays 320 are not. Since only desirable rays are used in this scenario and the opposing nature of wavefronts is advantageously used.

The ability to establish a high converging angle for opposing groups of wavefronts is desirable, as would be the case for a center occluded lens, but it is currently not possible to maximize NA when the objective lens is relatively far from the media. The ability to continuously vary the exact beam placement along the horizontal axis in which the converging behavior is being controlled, is desirable and is made possible when the objective lens is relatively far from the media.

### SUMMARY OF THE INVENTION

The present invention is a numerical aperture device and method. According to an embodiment of the present invention, a beam from a light source is caused to contact a numerical aperture (NA) plate or device. The NA plate has a first surface, a second surface, and an internal area. The first surface splits the beam into two twin rays and directs the twin rays into re-direction elements within the first surface of the NA plate. The two twin rays are directed in opposite directions from each other such that they traverse a specific distance through the internal area of the NA plate before striking the second surface of the plate. In one embodiment, the specific distance is approximately equal to and/or equal to the anticipated distance of the NA plate from the medium. The second surface of the NA plate is structured such that the twin beams are again re-directed. As the twin beams leave the NA plate's second surface they converge together and meet at the location of the medium to produce a spot.

Since the beams have been re-directed through the NA plate, the twin beams are similar to the converging angle of beams at the outer edges of a closely placed objective lens. The NA plate, however, may be positioned at an arbitrary distance from the medium. Typically, the horizontal distance in which the twin beams travel between the first and second surfaces of the NA plate are directly related to the distance away from the medium the NA plate is positioned.

### DETAILED DESCRIPTION OF THE INVENTION

The present invention is a numerical aperture device and method. New configurations have been developed where tracking and focusing techniques have been enhanced in such a manner that the optical head apparatus need not be very close to the medium to operate effectively, and in fact it is advantageous for the optical head apparatus, in certain scenarios, to be farther away from the medium (disc) for enhanced functionality. One such system is described in connection with a co-pending patent application entitled “Low Seek Time Optical Disc Tracking System”, filed on Dec. 22, 2004, and having application Ser. No. 10/905,231, (the disclosure of which is herein incorporated by reference).

In the “Low Seek Time Optical Disc Tracking System” it was described how to perform tracking in an optical media player without using a radially moving sled and/or a rotating medium (disc). In another co-pending patent application entitled “Method and Apparatus for Differing Focus Between At Least Two Dimensions”, filed on Feb. 16, 2005, and having application Ser. No. 10/906,364, (the disclosure of which is herein incorporated by reference) it was described how to improve focus from a distance in an environment, for instance, where tracking is performed without the need for a sled and/or a rotating medium.

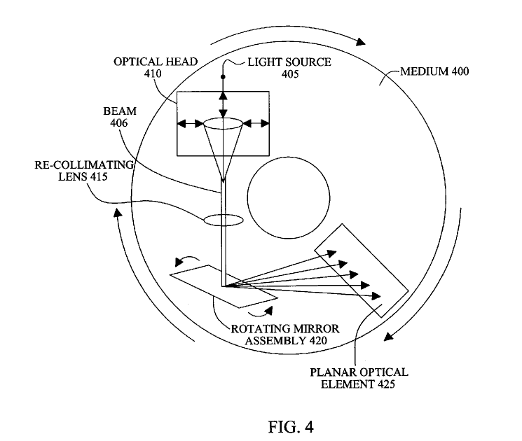

The above disclosures provide two examples of where it is advantageous to minimize the size of a spot produced on a medium, yet still be flexible enough to place the optical head farther from the medium, have the medium remain stationary, and/or eliminate the radial sled motion in the optical head apparatus. Many more examples exist. In general, the present invention applies in any environment where an optical head apparatus performs a focusing operation, in order to impinge a spot from a light source on a medium. One such example is described in connection with FIG. 4.

In FIG. 4 a medium 400 is rotated in a manner that is conventional to current optical media players. A light source 405 causes a beam 406 to pass through optical head 410, which is similar to a conventional optical head, but has its motion in the radial direction fixed. Otherwise, optical head 410 operates as a conventional optical head, including precision movements in at least two dimensions, so that it can still perform the conventional operations of focusing and fine-tracking, to keep the beam 406 focused on the desired track on the medium 400. A re-collimating lens 415 directs the beam 406 to a re-direction assembly 420. The re-direction assembly 420 is configured to cause the beam 406 to contact optical element 425 in any of a plurality of locations on its surface. Optical element 425 eventually guides the beam to its final destination on the medium 400.

The re-collimating lens 415 makes the beam 406 narrow but mostly straight. Because of the operation of the re-collimating lens 415, the beam 406 converges in one dimension to be very small (e.g., one track) at the surface of the medium 400. In the other dimension the beam 406 ends up being larger (e.g., many spots wide) by the time it hits the optical element 425. The larger size may comprise the equivalent of several track widths. The re-direction assembly 420 deflects the beam 406 widely along a given path to a specific location on the medium 400 that is continually selectable in the radial dimension. The optical element 425 converges the beam 406 in the axial dimension and allows and/or assists the beam 406 to continue converging in the radial dimension, resulting in a small, focused circular spot upon the medium 400 that has a fixed axial location and a continuously scannable radial location. The final focusing job performed by the optical element 425 affects essentially the axial focus only, leaving the radial focus unaffected and free to continue to converge onto the medium 400 at closer to the same angle it had prior to contacting the optical element 425.

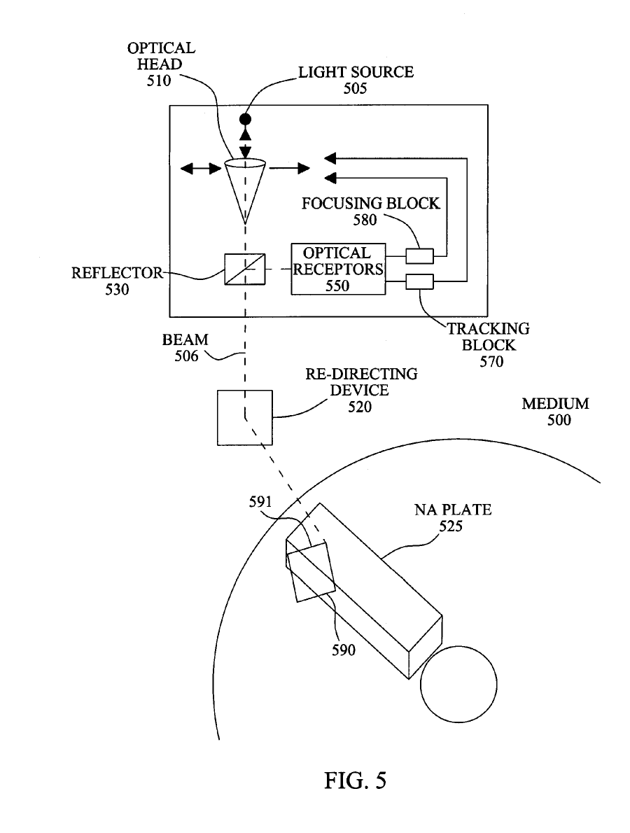

Thus FIG. 4 provides one example of an environment where focusing is desirable from a distance. Specifically with respect to FIG. 4, optical element 425 can be used in a manner that is consistent with the diagram shown in FIG. 5. In FIG. 5, a light source 505 causes a beam 506 to pass through optical head 510. A redirecting device 520 is configured to cause the beam 506 to contact NA plate 525 in any of a plurality of locations on its surface. NA plate 525 re-directs the beam and eventually guides the beam to its final destination on the medium 500.

The beam 506 reflects off medium 500 and follows the same path, eventually returning to a reflector 530, which causes the beam to enter optical receptors 550. Signals output from optical receptors 550 are used in tracking block 570 and focusing block 580 to adjust optical head 510 as appropriate in a feedback loop. NA plate 525 is configured to transform beam 506 into first and second beams 590 and 591 that are diverted by 90 degrees in opposing directions and then 90 degrees again before leaving NA plate 525 and converging onto medium 500 taking advantage of opposing wavefronts as shown in FIG. 3.

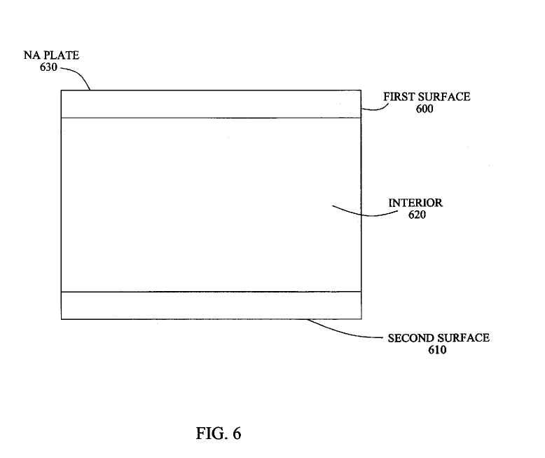

The NA plate has a first and second surface typically comprising a series of re-directing devices. FIG. 6 is a block diagram of an NA plate according to an embodiment of the present invention. NA plate 630 comprises a first and second surface 600 and 610 surrounding an interior area 620. Interior area may be constructed from a variety of materials such as glass or plastic, but preferably has the property of allowing a beam of light to travel through it relatively unobstructed.

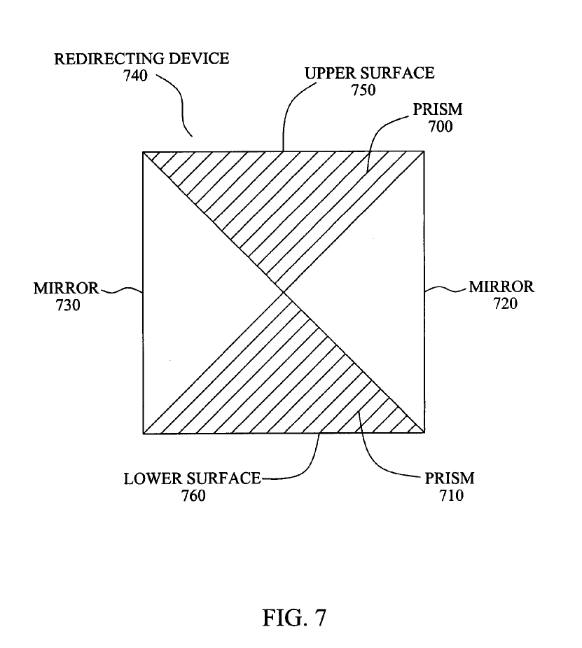

FIG. 7 is a block diagram of an embodiment of a redirecting device for use on the first and second surfaces of the NA plate. Redirecting device 740 comprises a first prism 700 and a second prism 710. Perpendicular to prisms 700 and 710 are placed mirrors 720 and 730. When a beam enters prism 700 in a direction perpendicular to upper surface 750 the beam is split into two twin rays and directed to strike mirrors 720 and 730 and into adjacent and oppositely oriented reflector prism 710. The two twin rays are directed in opposite directions from each other (and 90 degrees apart from each other) as they exit a lower surface 760 of prism 710. A plurality of devices like redirecting device 740 can be used to cover an entire surface of an NA plate, for instance.

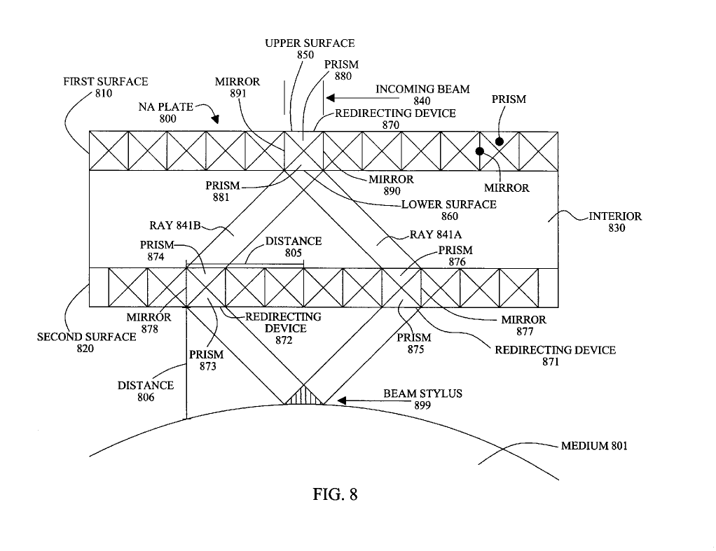

FIG. 8 is a block diagram of an NA plate according to an embodiment of the present invention. NA plate 800 comprises a first and second surface 810 and 820 surrounding an interior area 830. Interior area may be constructed from a variety of materials, such as glass or plastic, but preferably has the property of allowing a beam of light to travel through it relatively unobstructed. On the first and second surfaces 810 and 820 of NA plate 800 are a plurality of redirecting devices, in this example comprising an arrangement of micro-prisms and mirrors, for instance as shown with regard to FIG. 7.

An incoming beam 840 strikes one of the plurality of micro-prisms on first surface 810. In this instance, redirecting device 870 is first contacted by beam 840 on its upper surface 850 of prism 880 in a direction perpendicular to upper surface 850. Consequently, beam 840 is split into two twin rays 841a and 841b and directed to strike mirrors 890 and 891 and into adjacent and oppositely oriented reflector prism 881. The two twin rays 841a and 841b are directed in opposite directions from each other (and 90 degrees apart from each other) as they exit a lower surface 860 of prism 881 and into interior area 830.

The two twin rays are directed in opposite directions from each other (and 90 degrees apart from each other) such that as they traverse a specific distance through the interior 830 before striking the second surface 820 of the NA plate 800 at other redirecting devices. In the embodiment of FIG. 8, the specific distance 805 is the horizontal distance traveled by beams 841a and 841b while in the interior 830 and is approximately equal to and/or equal to the anticipated distance 806 of the NA plate from a medium 801.

The second surface 820 of the NA plate 800 is structured such that the twin beams 841a and 841b are again re-directed at 90 degree angles via the combination of micro-prisms and mirrors. In this instance, redirecting devices 871 and 872 use prisms 873, 874, 875, and 876 and mirrors 877 and 878 for a 90 degree redirection. As the twin beams leave the second surface 820 of the NA plate 800 they converge together and meet at the location of beam stylus 899 on the medium 801 to produce a spot.

Since the beams have been re-directed through the NA plate 800, the twin beams 841a and 841b are similar to the converging angle of beams at the outer edges of a closely placed objective lens. The NA plate, however, may be positioned at a distance from the medium. By the converging of the twin beams 841a and 841b one from a left group and one from a right group upon a certain point in a certain focal plane shown as beam stylus 899, an opposing wavefront is established. To the extent to which the focal plane of the right angle convergence matches the focal plane of the long distance convergence, there is a high NA wavefront convergence effect characteristic of the “hollow beam” from a center-occluded objective lens close to the media.

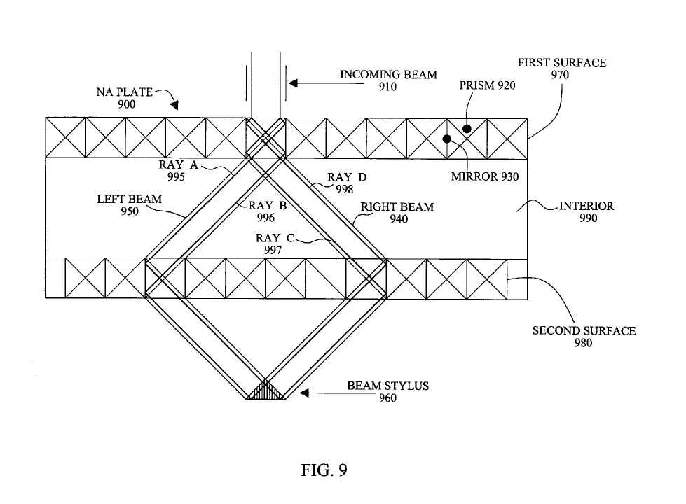

FIG. 9 is a block diagram of an NA plate, which shows the path a beam might take when passing through. NA plate 900 comprises a plurality of redirecting devices on its first and second surfaces 970 and 980 as well as an interior area 990. Prism 920 and mirror 930 are shown by way of example to represent the plurality of such devices along the surfaces 970 and 980 of NA plate 900. Incoming beam 910 in this example is split along the paths shown by rays a, b, c, and d numbered 995, 996, 997, and 998 respectively. Rays 995 and 996 make up a left beam 950. Rays 997 and 998 make up a right beam 940. Right beam and left beam 940 and 950 come into contact at a certain point at a certain focal plane denoted as beam stylus 960 where they are combined to produce a spot.

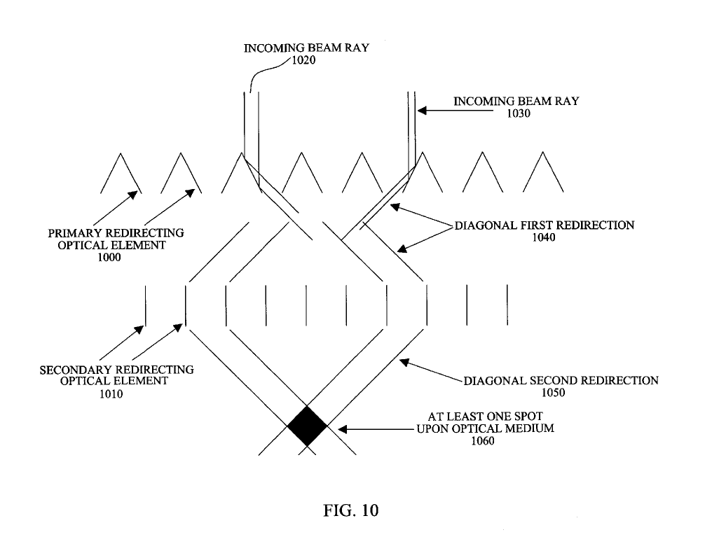

Another embodiment of the present invention is shown in FIG. 10. An arriving group of incoming beam rays 1020 and 1030 are divided into opposite divisions of rays 1040. Somewhat parallel incoming beam rays 1020 and 1030 are shown as entering a primary optical element 1000 at a certain distance from each other. This is intended to demonstrate that according to the present invention, the division of rays into opposing groups may or may not be accomplished by adjacent faces of the primary optical element. Furthermore, the diverging distance and or reconverging distance may or may not be significantly larger than the scale shown in comparison to the size of each presenting face of the primary optical element and secondary optical elements. It is also important to understand that there is not of necessity a uniformity in scale between the primary optical element and the secondary optical element, or the faces thereof.

As such, opposing ray groups traverse the diverging distance from the primary redirecting optical element 1000 toward a secondary redirecting optical element 1010, the opposing ray groups attain significant distance from each other (along the dimension of opposition) by the time they reach the secondary redirecting optical element 1010. The opposing ray groups are then redirected by the secondary redirecting optical element 1010 in direction 1050, toward the vicinity of a single location (along the dimension of opposition) on the optical medium in order to form at least one spot 1060.

Since the opposing ray groups have diverged significantly from each other in the dimension of opposition as they traversed the diverging distance, the converging of the two groups at a reconverging angle creates an opposing wavefront composed of rays at a very high angle of incidence (from the axis that in at least one dimension is significantly central to the average of all rays striking the media surface), resulting in a very high value for the NA. This very high angle of incidence shall herein be called the synthetic convergence angle.

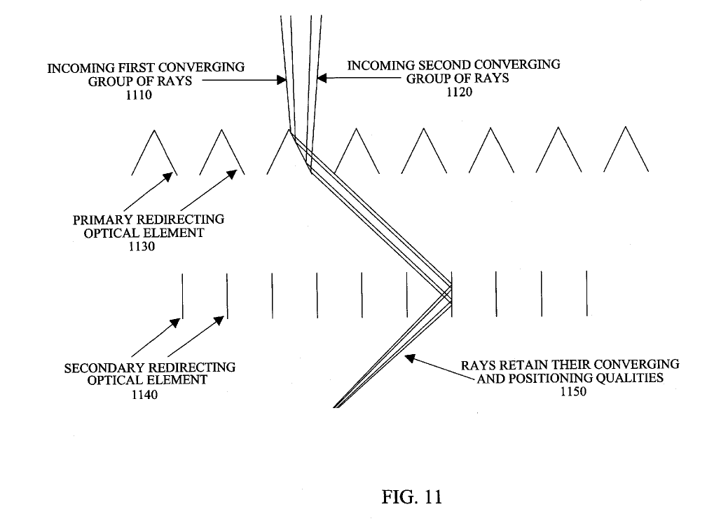

Since the synthetic convergence angle is essentially uniform across the dimension of opposition, there is a continuous tracking capability whereby the incoming beam can track in essentially a continuously variable fashion across the dimension of opposition. This is shown in FIG. 11, where incoming, converging groups of rays 1110 and 1120 strike a primary redirecting optical element 1130 and then a secondary redirecting optical element 1140. Rays 1110 and 1120 have a dimensionality of pre-established ray convergence and pre-established beam tracking as shown at location 1150. The rays within a certain ray group do not differ much from each other in converging angle. Neither do the rays within a certain other ray group. But there is an opposing wavefront established by the converging of the left ray group and the right ray group upon a certain point in a certain focal plane. The converging angle of the incoming beam is called the long distance convergence. To the extent to which the focal plane of the convergence of the two ray groups matches the focal plane of the long distance convergence (when present), there is a high NA wavefront convergence effect characteristic of the “hollow beam” from a center-occluded objective lens close to the media.

The NA plate need not be a permanently fixed structure. In one embodiment, the NA plate is actively maintained at the optimum distance from the spinning media (albeit in a slower servo loop than present focus loops) to minimize the gross focus error between the long distance convergence of rays within the same left or right group, and the right angle convergence (synthetic convergence angle) of the left group with the right group.

The material that establishes the distance within the NA device may be piezo-electric or otherwise electro-convulsive, such that for high frequencies the fine focus can be adjusted between the focal planes established by the long distance convergence and the synthetic convergence angle. An internal or external device may flex the NA plate such that rather than (or in addition to) having the internal distance changed, it would warp to achieve a particular momentary synthetic convergence angle.

The NA plate may be a standard part of the media, such that all units that write and read such media would be designed to interface with media that is covered with the device. This would guarantee a minimum focus error between the focal planes established by the long distance convergence and the synthetic convergence angle. The NA device is shown in a two dimensional form. The third dimension can be applied in various ways:
a. The two dimensional shape can be extended straight back for each and every two-dimensional point shown, such that each optical element would perform a similar function across a third dimension.
b. The third dimensional extension can be as above, but instead of being straight, the optical elements can have (in the third dimension versus the dimension of distance to the media) a curve that completes or at least adjusts the job of focusing the beam upon the media within that third dimension.
c. The pattern seen from the front could be similar to the pattern as seen from the side, such that the beam would have a synthetic convergence in both the second and third dimension (where the first dimension is the distance from the media).

The NA plate may operate upon a beam with no long distance convergence. In such a case the primary optical device and secondary optical device may operate on a line (or grid) of beam target locations, or upon sectors thereof. In any case, the incoming beam may be split prior to entry into the primary optical device, to facilitate the distribution of rays into “opposing ray groups” (the groups producing opposing wavefronts) for groups of rays, target spot sized beams (in at least one dimension), or even single rays.

A beam concentrating optical device may precede the primary optical device, such that the beams which would normally be lost by not entering one of primary optical device's active portions (places of ray entry where such rays end up included in any group of opposing ray groups creating synthetic convergence) can instead be concentrated so as to enter the active portions of primary optical device. Such beam concentrating optical device may comprise one or more beam concentrating optical elements.

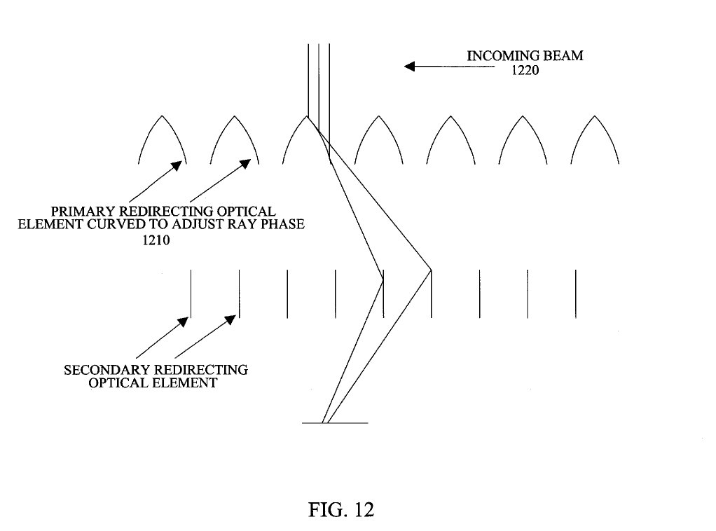

The reflective surfaces (or refractive boundaries) of the primary optical device and secondary optical device may be curved as shown in element 1210 of FIG. 12, in order to compensate for beam ray phase(s) and angle(s) of convergence, provided that the essential task of the NA plate is still allowed to operate, namely that the beam 1220 is given a synthetic convergence angle upon the optical medium while the beam is yet able to be continuously tracked across a dimension of opposition (relative to the NA plate) prior to entering the primary optical device, without suffering such a change in beam ray incidence angles as would render associated focus drive unable to maintain focus.

There may be additional optical incidence adjusting device(s) prior to the primary optical device, (at least functionally) between the primary optical device and the secondary optical device, or (at least functionally) between the secondary optical device and the optical media. Such additional optical incidence adjusting device(s) may be serve a variety of purposes including but not limited to: adjustment of wavefront phase, beam shaping, beam sharpening, beam dilating, focus adjustment, beam spot target sectorization (the gathering of incoming rays or ray groups into distinct locational groupings upon the primary optical device, upon the secondary optical device and or upon the optical media), fine tracking (see requirement above), aspect ratio control and spot size control.

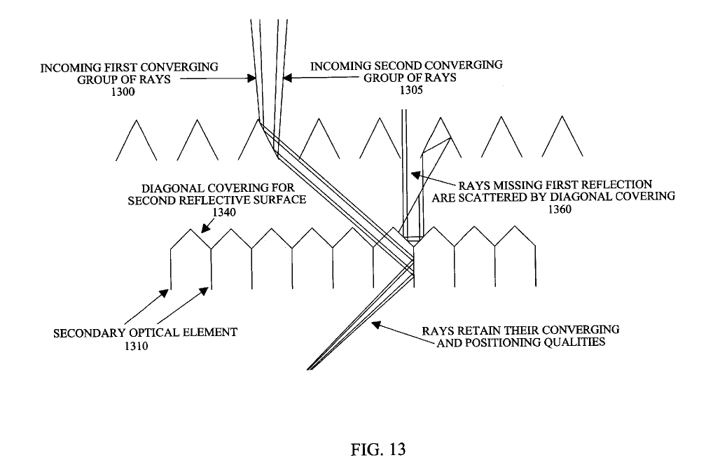

The function of the NA plate may be divided across more than one device, where there is no direct connection between the primary optical device and the secondary optical device. There may be a diagonal covering, as shown in element 1340 of FIG. 13, for the secondary optical element 1310, such that incoming rays 1300 and 1305 pass unaffected through the covering 1340, but rays 1360 missing first reflection are scattered by the diagonal covering 1340 to prevent concentrations of unintended focus.

Notable Benefit: The present invention reduces the minimum spot size for the same laser operating without the present invention. Since the minimum spot size=0.6*780/NA, changing the NA from 0.53 to 1.0096 cuts the IR spot size down from 883 nM to 427 nM (up to 2.5 gig on a 120 mm disc with smaller track pitch.) Blue Ray already uses a 0.85 NA so a 1.0096 NA yields a 44% increase in potential density. Moreover, the ability to focus so small from a distance, allows extremely fast tracking and seeking mechanisms to be utilized without sacrificing in the parameter of spot size.

Although the description above contains many specificities, these should not be construed as limiting the scope of the invention but as merely providing illustrations of some of the presently preferred embodiments of this invention. Thus the scope of this invention should be determined by the appended claims and their legal equivalents.

1. An apparatus comprising:
a light source; and
a plate for receiving a beam from said light source, said plate comprising a first surface, a second surface, and an internal area between said first and second surfaces, said first and second surfaces comprising a plurality of redirecting devices.

2. The apparatus of claim 1 wherein said redirecting devices further comprise:
a first prism,
a second prism, said first and second prisms being oppositely oriented, and
at least one mirror, said mirror being oriented perpendicular to said first and second prisms.

3. The apparatus of claim 2 wherein said beam contacts an upper surface of one of said first prisms in one of said redirecting devices thereby causing said beam to split into a right beam and a left beam.

4. The apparatus of claim 3 wherein said one of said redirecting devices has a first and a second mirror, said first and second mirrors being perpendicular to said oppositely oriented first and second prisms, said first mirror reflecting said left beam at a first angle, said second mirror reflecting said right beam at a second angle.

5. The apparatus of claim 4 wherein said first and second angles are 90 degrees.

6. The apparatus of claim 5 wherein said left and right beams diverge after leaving a lower surface of said second prism and enter said internal area of said plate.

7. The apparatus of claim 6 wherein said left and right beams contact said second surface of said plate after traveling a distance.

8. The apparatus of claim 7 where a horizontal component of said distance corresponds to a distance between said plate and a medium.

9. The apparatus of claim 8 wherein said left beam contacts a left redirecting device on said second surface of said plate and said right beam contacts a right redirecting device on said second surface of said plate.

10. The apparatus of claim 9 wherein said left and right beams exit said second surface of said plate at left and right lower surfaces of said left and right redirecting devices in a manner wherein said left and right beams converge.

11. A method comprising:
directing a beam to a plate, said plate comprising a first surface, a second surface, and an internal area between said first and second surfaces, said first and second surfaces comprising a plurality of redirecting devices; and
causing said beam to be redirected within said plate at said first and second surfaces.

12. The method of claim 11 wherein said redirecting devices include a first prism, further comprising, splitting said beam into a right beam and a left beam when said beam contacts an upper surface of said first prism at a 90 degree angle.

13. The method of claim 12 wherein said redirecting device includes a second prism being oppositely oriented to said first prism and a first and a second mirror, said first and second mirrors being perpendicular to said oppositely oriented first and second prisms, further comprising:
reflecting said left beam at a first angle with said first mirror; and
reflecting said right beam at a second angle with said second mirror.

14. The method of claim 13 wherein said first and second angles are 90 degrees.

15. The method of claim 14 further comprising, causing said left and right beams to diverge after leaving a lower surface of said second prism and entering said internal area of said plate.

16. The method of claim 15 further comprising causing said left and right beams to contact said second surface of said plate after traveling a distance.

17. The method of claim 16 where a horizontal component of said distance corresponds to a distance between said plate and a medium.

18. The method of claim 17 further comprising:
causing said left beam to contact a left redirecting device on said second surface of said plate; and
causing said right beam to contact a right redirecting device on said second surface of said plate.

19. The method of claim 18 further comprising:
causing said left beam to exit said second surface of said plate at a lower surface of said left redirecting device in a first direction;
causing said right beam to exit said second surface of said plate at a lower surface of said right redirecting device in a second direction, wherein said first and second directions converge.

20. A system comprising:
a light source means; and
a plate means for receiving a beam from said light source means, said plate comprising a first surface, a second surface, and an internal area between said first and second surfaces, said first and second surfaces comprising a plurality of redirecting device means.

21. The system of claim 20 wherein said redirecting device means further comprise:
a first prism,
a second prism, said first and second prisms being oppositely oriented, and
at least one mirror, said mirror being oriented perpendicular to said first and second prisms.

22. The system of claim 21wherein said beam contacts an upper surface of one of said first prisms in one of said redirecting device means thereby causing said beam to split into a right beam and a left beam.

23. The system of claim 22 wherein said one of said redirecting device means has a first and a second mirror, said first and second mirrors being perpendicular to said oppositely oriented first and second prisms, said first mirror reflecting said left beam at a first angle, said second mirror reflecting said right beam at a second angle.

24. The system of claim 23 wherein said first and second angles are 90 degrees.

25. The system of claim 24 wherein said left and right beams diverge after leaving a lower surface of said second prism and enter said internal area of said plate means.

26. The system of claim 25 wherein said left and right beams contact said second surface of said plate means after traveling a distance.

27. The system of claim 26 where a horizontal component of said distance corresponds to a distance between said plate means and a medium.

28. The system of claim 27 wherein said left beam contacts a left redirecting device means on said second surface of said plate means and said right beam contacts a right redirecting device means on said second surface of said plate means.

29. The system of claim 28 wherein said left and right beams exit said second surface of said plate means at left and right lower surfaces of said left and right redirecting device means in a manner wherein said left and right beams converge.

30. A system comprising:
a source;
a first optical device comprising one or more first optical elements, said first optical device capable of redirecting incoming rays from said source into a plurality of ray groups diverging from each other, wherein each said ray group of said plurality of ray groups comprises rays that within each ray group either converge, propagate parallel to each other or else diverge less than the divergence between one ray group and another; and
a second optical device comprising one or more second optical elements disposed in a path of said plurality of ray groups, said second optical device capable of further redirecting said rays received from said first optical device, wherein said rays arrive upon an optical medium in substantially a single location, and wherein an angle of incidence between a ray in a first ray group of said plurality of ray groups and a ray in a second ray group of said plurality of ray groups is significantly larger than the angle of incidence of edge rays within a particular ray group of said plurality of ray groups.
